(19) United States
(12) Patent Application Publication
(10) Pub. No.: US 2010/0293501 A1
(43) Pub. Date: Nov. 18, 2010

(54) Grid Windows

(75) Inventors: Kevin Russ, Bellevue, WA (US); John Snavely, Seattle, WA (US); Ian Sands, Seattle, WA (US); Russ Burtner, Everett, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/467,983

(22) Filed: May 18, 2009

(51) Int. Cl. G06F 3/048

(52) U.S. Cl. 715/803

(57) ABSTRACT

Embodiments of the present invention are directed toward facilitating multi-user input on large format displays. In situations where multiple users may want to work individually on separate content, or individually on the same content, embodiments of the present invention provide an interface allowing a user or users to segment a display in a way to create isolated areas in which multiple users may manipulate content independently and concurrently.

### BACKGROUND

Graphical user interfaces (GUIs) have become a ubiquitous computing technology. The utilization of GUIs provides an easy and intuitive means to run multiple software applications simultaneously on a computing device and share display space among multiple running software applications. Recent developments in large format multi-touch graphical user interfaces (GUIs) have led to further development of concurrent multi-user input technology. Large format displays are ideal in business meetings, in educational settings, and in any place where interactive presentations are given frequently. When multiple users are working on a large-scale, multi-touch display system, it is often desirable to have separate work areas that can be manipulated independently and concurrently and that allow users to divide a display into spatially remote work areas. It is with respect to these and other considerations that the present invention has been made.

### SUMMARY

Embodiments of the present invention provide an interface for allowing a user to segment a display to create isolated areas in which multiple users may manipulate content independently and concurrently. According to one embodiment, a grid system for large-format displays is provided, which allows a plurality of work areas or grid windows to be created within a single display where each grid window may be populated with independent application functionality and associated content. The display area may be divided into independent work areas that may be linked to multiple sources and used by multiple users at the same time. The independent work areas, or grid windows, may contain the same data as other grid windows or may contain separate data as configured by a user. Grid windows may be instantiated by dragging new dividers from the edges of the display area or also from existing grid windows. In one embodiment, a grid window may be separated into two or more grid windows so that two or more users may work separately on the same content.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is an example display containing a single grid window.

FIG. 2 is an example display illustrating how a second grid window may be created, wherein the second grid window contains an instanced copy of the content contained in the original grid window.

FIG. 3 illustrates a configuration of grid windows.

FIG. 4 illustrates a grid window configuration in which a divider is dragged and pushes smaller dividers along with it.

FIG. 5 is an example display of a grid window configuration illustrating how a grid window may be collapsed.

FIG. 6 is an example of a sample flow of grid window utilization.

FIG. 7 is a block diagram showing the architecture of an electronic computing device that provides an illustrative operating environment for embodiments of the present invention.

### DETAILED DESCRIPTION

As briefly described above, embodiments of the present invention are directed to facilitating multi-user input on large format displays. In situations where multiple users may want to work individually on separate content, or individually on the same content, the present invention provides an interface allowing a user or users to segment a display in a way to create isolated areas in which multiple users may manipulate content independently and concurrently.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

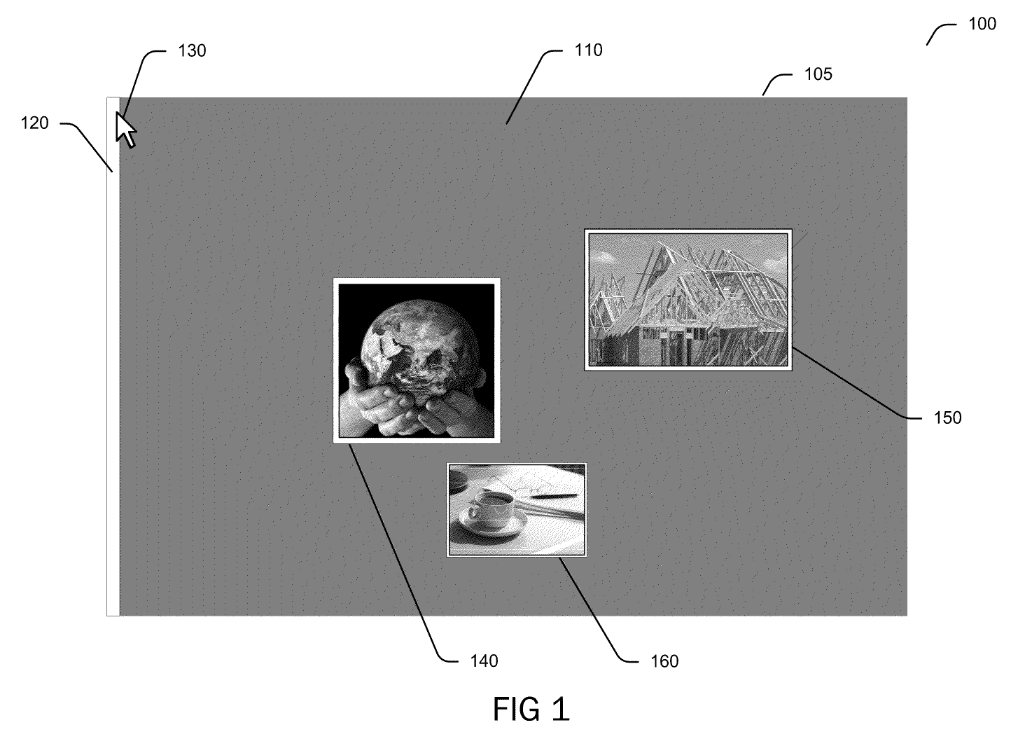

The Grid Windows user interface 100 of the present invention allows a user to create, designate, manage, and manipulate computer-enabled display space as individual work areas or display windows, which may herein be referred to as grid windows. FIG. 1 is an illustration of an example display 105 showing a single grid window 110. According to one embodiment, display 105 may be a large multi-touch display such as the TOUCH WALL or SURFACE by MICROSOFT CORPORATION of Redmond, Wash., an electronic whiteboard, or the like. According to other embodiments, display 105 may be a monitor, tablet, or mobile phone display. As should be appreciated, display 105 may be any number of displays known in the art and should not be limited to large format displays only.

On the example display 105, a single grid window 110 is shown containing three displayed photographs 140, 150, 160. A grid window 110 is a window or visual workspace wherein output may be displayed, input may be entered, and data may be manipulated. According to an embodiment, a plurality of separate display windows or grid windows 110 may be displayed within a display window 105. On a display containing multiple grid windows 110, each grid window 110 may contain independent application functionally 705 and/or contain data from multiple sources. According to one embodiment, a first grid window 110 may contain a first content, and a second grid window may contain an instance of the first content. For example, a first application functionality 705, for example, WORD by MICROSOFT CORPORATION of Redmond, Wash., may be utilized in the first grid window 110. The first application functionality 705 may also be utilized in the second grid window 110 independently of the first application functionality of the first grid window. The first application functionality 705 and the instance of the first application functionality in the first and second grid windows 110 may also be utilized concurrently with each other. As should be appreciated, a plurality of grid windows 110 may display content utilizing a plurality of independently and concurrently running application functionalities 705.

According to an embodiment, various multiple application functionalities 705 may be utilized in multiple grid windows 110. That is, a first grid window 110 may contain a first content, and a second grid window may contain a second content. A first application functionality 705, for example, WORD by MICROSOFT CORPORATION of Redmond, Wash., may be utilized in the first grid window 110. A second application functionality 705, for example, EXCEL by MICROSOFT CORPORATION, may be utilized in the second grid window 110. The first and second application functionalities 705 may be utilized independently of each other and also concurrently with each other.

As an example, four individuals may approach a display 105 and drag out four separate grid windows 110. Each individual may call up his/her individual computers displaying his/her own personal data and content. Each individual may work on his/her own personal data and content side by side on the same display; however, the source, data and content for each grid window 110 may be completely different. One individual may be referencing his/her mobile device in his/her pocket for content; another may be referencing his/her data via a distributed computing network such as the Internet; and another may be accessing his computing device in his office. According to an embodiment, a grid window 110 may be in itself a desktop environment, within which multiple windows and/or applications may be displayed.

According to an embodiment, data contained in one grid window 110 may be bound to data contained in another grid window so that when data is changed in one grid window, elements that are bound to the data reflect the corresponding changes automatically. According to another embodiment, if a second grid window 110 contains an instantiation of data contained in a first grid window, and if the instantiation of the data of the first grid window contained in the second grid window is changed, then the underlying data in the first grid window may be automatically updated to reflect the changes. For example, a spreadsheet may be displayed in a first grid window 110, and an instantiation of the same spreadsheet may be displayed in a second grid window. The data contained in the second grid window may be bound to the data contained in the first grid window. If a user manipulates the data in the spreadsheet of the second grid window 110, (e.g., changes a value of a number contained in a cell of the spreadsheet), the data contained in the corresponding cell of the spreadsheet contained in the first grid window may automatically update to reflect the change. As should be appreciated, data may be bound in various ways such as, but not limited to, one-way binding, two-way binding, one-way-to-source binding, or one-time binding. As should be appreciated, data binding is a technology known in the art and will not be discussed at length herein.

Referring still to FIG. 1, a divider 120 is shown. According to an embodiment, dividers 120 are operative to divide a display 105 and define grid windows 110. If a divider 120 is selected from the edge of the display 105, moved across the display, and deposited at a desired location over a first grid window, a second grid window may be created on an opposite side of the deposited divider.

According to another embodiment, dividers 120 may also be operative to instantiate new grid windows 110. If a divider 120 is selected from the edge of the display 105, moved across the display, and deposited over the first grid window, an instance of a first content of the first grid window may be displayed in a second and separate grid window. For example, if a document is open in a grid window 110, a user may drag out a divider 120 from the edge of the display 105, and drag the divider across the document. Accordingly, the content of the grid window 110 may be instantiated for presenting two grid windows 110 with the same content in each grid window that may be manipulated separately and concurrently.

According to another embodiment, a new edge may be established for each of the first and second grid windows 110 at the location of the deposited divider 120 between the first and second grid windows. A second divider 120 may be instantiated over the new edge, wherein the second divider may be moved to a second desired location in either the first or second grid windows for separating the first or second grid window into multiple grid windows. As should be appreciated, the new edge may be established and the second divider instantiated by various methods, such as selecting a divider and holding it until it is activated, selecting a combination of keystrokes, making a selection from a context menu, selecting a shortcut key, or by other methods known in the art. For example, if a user is utilizing a keyboard, he/she may select a divider 120 and press a modifier key and an additional key. Accordingly, a new edge may be established and a second divider may be instantiated over the new edge. The second divider may then be moved over a displayed grid window 110 and deposited on it in a desired location. Accordingly, a new grid window may be created on one side of the deposited divider.

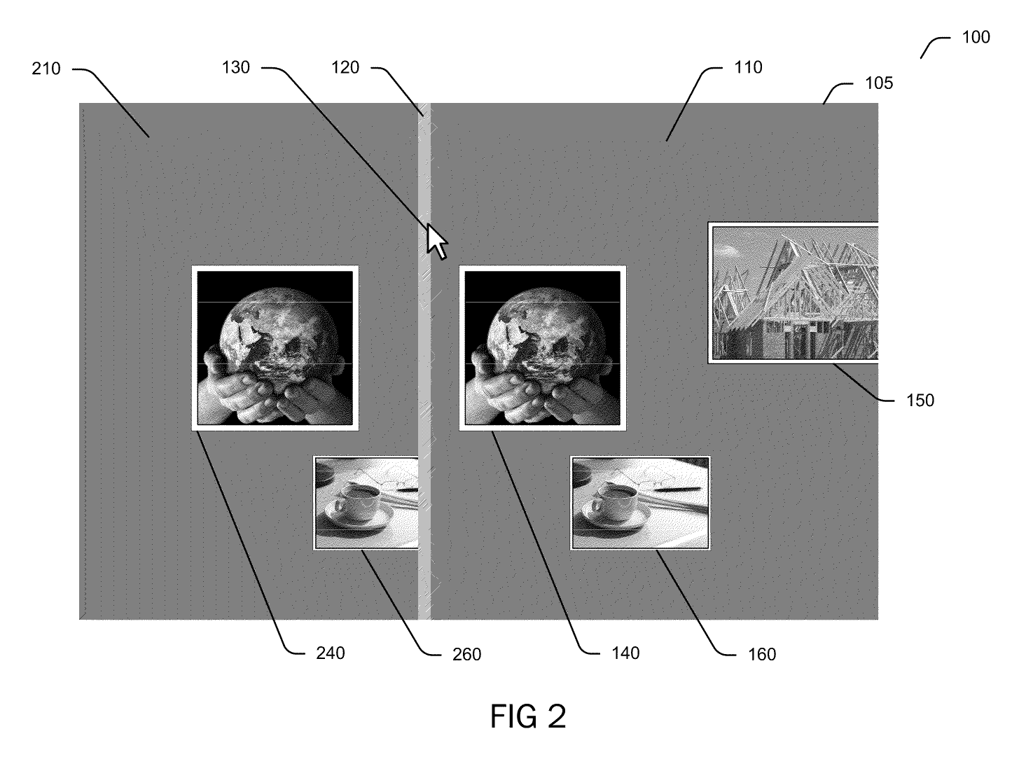

As an example interaction, still referring to FIG. 1, a user may be working on a large display 105. Another user may want to work with the same content 140, 150, 160, but separately from the first user. One of the users may select the divider 120 and drag it over the grid window 110. Referring now to FIG. 2, by dragging the divider 120 over the existing grid window 100, the display 105 is split into two grid windows 110,210 with a vertical divider 120. As shown, the new grid window 210 displays new instances of the same content (e.g., photographs 240, 260) as in the initial grid window 110 (e.g., photographs 140, 150, 160). In the example display 105, the instantiated photograph 150 is not shown because of the display size of the new grid window 210. It should be appreciated that a user may choose to pan over or zoom out to view all of the content, which would then display an instantiated copy of photograph 150. Each grid window 110, 210 may be utilized separately and concurrently, allowing each user to navigate respective grid windows 110, 210 independently.

If a user or users are using a large format display, such as a wall-sized display or large electronic white board display, access to the dividers 120 of the display 105 may be difficult to reach. According to an embodiment, a user or users may be able to use gestures that would allow him/her to position dividers 120. According to another embodiment, multi-touch input may be used to select and position dividers 120. A cursor 130 is shown in FIGS. 1 and 2, which is an indicator of the position on the display 105 that will respond to input from a pointing device. It should be appreciated that the pointing device may be a mouse, stylus, touch or multi-touch input, gesture, or any other input or selection mechanisms known in the art.

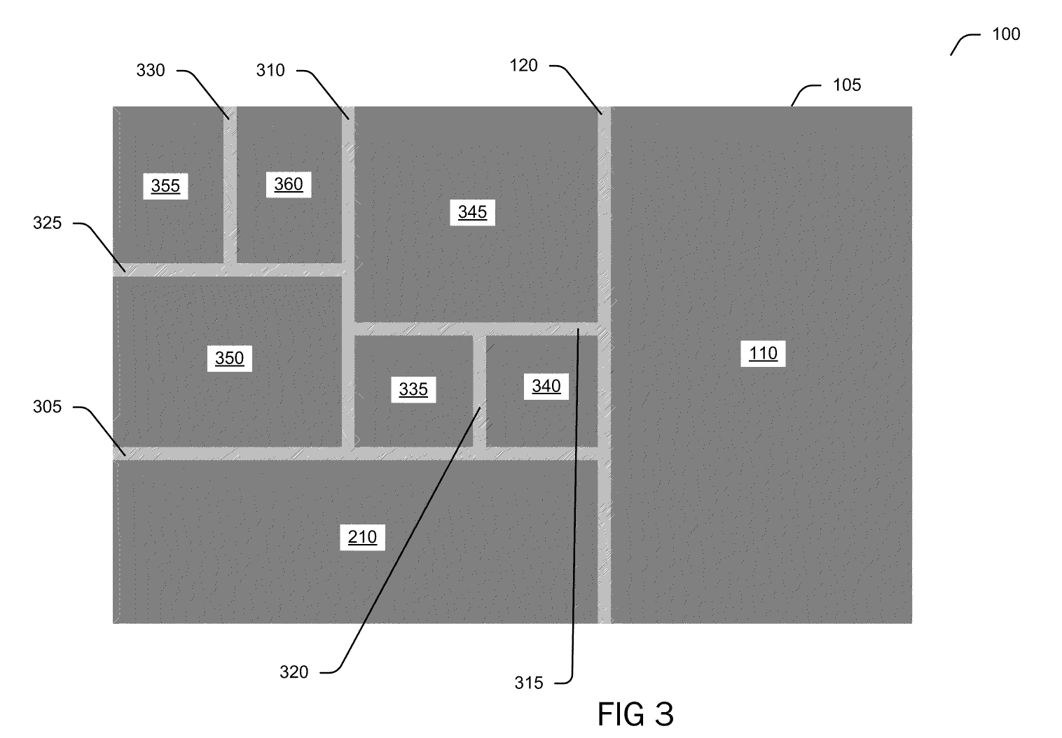

Referring now to FIG. 3, a configuration of grid windows 110, 210, 335, 340, 345, 350, 355, 360 is shown on display 105. Also depicted are grid window dividers 120, 305, 310, 315, 320, 325, 330. As shown in FIG. 3, grid windows 110, 210, 335, 340, 345, 350, 355, 360 may be created with either horizontal or vertical dividers 120, 305, 310, 315, 320, 325, 330. If a horizontal divider 305,315,325 is selected and moved from an edge of the display and deposited over a grid window 110, or if a horizontal divider is selected, instantiated, and moved from an edge of an existing grid window, and deposited over a grid window, it may separate the said grid window into an upper and lower separate grid window. Alternatively, if a vertical divider 120,310,320,330 is selected and moved from an edge of the display and deposited over a grid window 110, or if a vertical divider is selected, instantiated, and moved from an edge of an existing grid window, and deposited over a grid window, it may separate the said grid window into side-by-side separate grid windows.

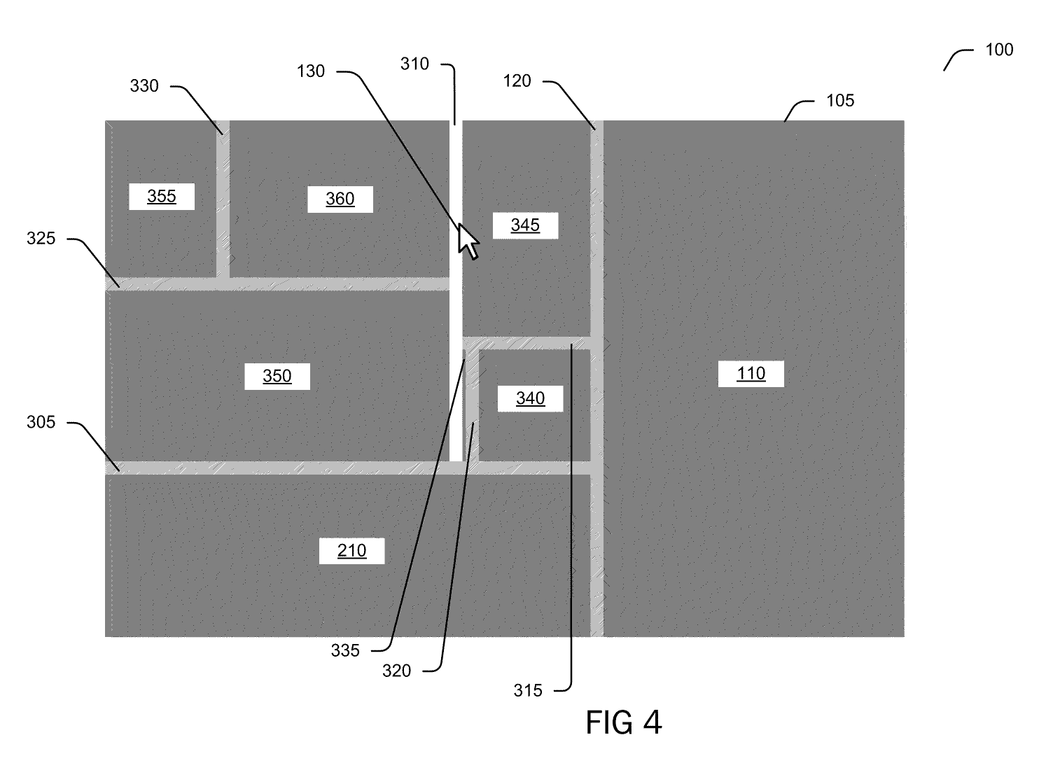

The grid window user interface 100 of the present invention permits the configuration and resizing of grid windows 110, 210, 335, 340, 345, 350, 355, 360 by moving and manipulating dividers 120, 305, 310, 315, 320, 325, 330. Dividers 120, 305, 310, 315, 320, 325, 330 may be moved to resize grid windows 110, 210, 335, 340, 345, 350, 355, 360 horizontally or vertically, respectively. For example, referring still to FIG. 3, divider 330 may be selected and dragged to the right. Accordingly, grid window 360 may decrease in size and grid window 355 may increase in size. The movement of dividers 120, 305, 310, 315, 320, 325, 330 may also be used to collapse grid windows 110, 210, 335, 340, 345, 350, 355, 360. According to an embodiment, if a divider 120, 305, 310, 315, 320, 325, 330 is moved over a grid window or multiple grid windows, and dragged into another divider such that the grid window(s) is/are removed from display, the grid window(s) 110, 210, 335, 340, 345, 350, 355, 360 between the dragged divider and the divider it is dragged into may be collapsed. Hierarchy rules may be established around the behavior for collapsing windows. According to one embodiment, a longer divider may push a smaller divider along with it. For example, as shown in FIG. 4, divider 310 has been selected and dragged to the right. As a result, grid windows 350 and 360 have grown in width, while grid windows 345 and 335 have become shortened in width.

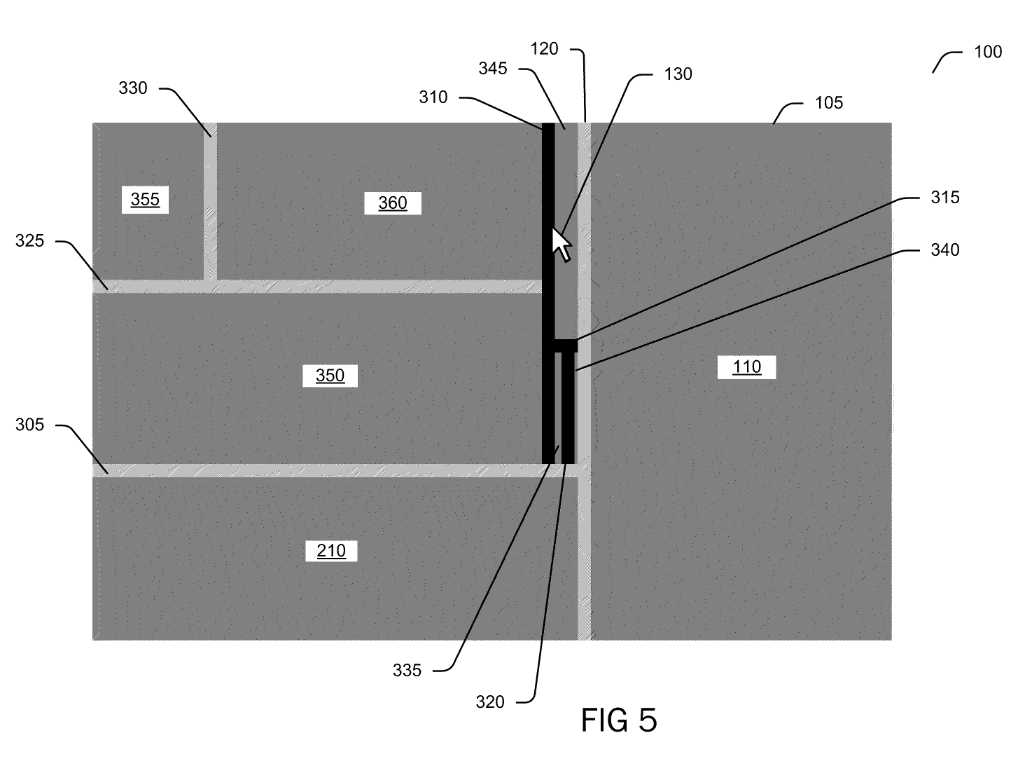

FIG. 5 is an example of how a grid window 110, 210, 335, 340, 345, 350, 355, 360 may be collapsed if a divider 120,305,310,315,320,325,330 is dragged into another divider of equal or greater length. Consequently, smaller grid windows 110, 210, 335, 340, 345, 350, 355, 360 contained within may be collapsed. As shown in FIG. 5, divider 310 has been selected and dragged to the right. As it is being dragged, it is also dragging the smaller divider 320 along until it hits another vertical divider that is larger 120. As shown in FIG. 5, according to an embodiment, dividers 120, 305, 310, 315, 320, 325, 330 may change in appearance to indicate that, if a user releases the divider, the associated grid windows will collapse. In FIG. 5, dividers 310, 315, and 320 are shown darkened, indicating that grid windows 335, 340, and 345 may be collapsed if the user releases the divider 310 he/she is dragging. Accordingly, the horizontal divider 325 may connect up to the next vertical divider 120.

Having described embodiments of the present invention with respect to FIGS. 1-5, FIG. 6 is an example logical flow diagram illustrating a method for providing a plurality of grid windows wherein independent application functionally and associated content may be displayed on a multi-touch display as described above.

The method 600 begins at operation 610 and proceeds to operation 620 where a user launches an application. As should be appreciated, a user may open an application and display it on a variety of display devices such as, but not limited to, monitors, tablets, mobile phone displays, large format displays, touchscreens, multi-touch devices, etc. For purposes of example, a user may open a word processing application, and the application window may be displayed within a grid window 110 on the display 105. As should be appreciated, a variety of desktop applications, for example, spreadsheet applications, slide presentation applications, database applications, and the like may be utilized.

The user may be utilizing the word processing application to create a word processing document. He/she may decide to separate the single grid window 110 into two grid windows so that he/she may create or manipulate the contents of the word processing documents independently. At operation 630, he/she may drag a divider 120 over the displayed grid window 110. Upon performing this operation 630, the display 105 may be split into two grid windows 110, wherein the new grid window may display new instances of the same content as the initial grid window 110. The user may then manipulate the word processing document in either grid window 110 without affecting the content of the other grid window.

The user may decide to divide the display 105 into three grid windows 110. At operation 640, he/she may drag another divider 120 one of the displayed grid windows to instantiate an additional grid window. Accordingly, three grid windows may be displayed, each displaying an instance of the same content.

At operation 650, two additional users may approach the display 105, each utilizing a displayed grid window. As should be appreciated, each user may work on the instantiation of the word processing document; or alternatively, each user may work on separate content and may be utilizing independent applications. For example, one user may be manipulating the word processing document utilizing a word processing application, one user may be creating a spreadsheet utilizing a spreadsheet application, and the third user may be checking his e-mail utilizing an electronic mail application.

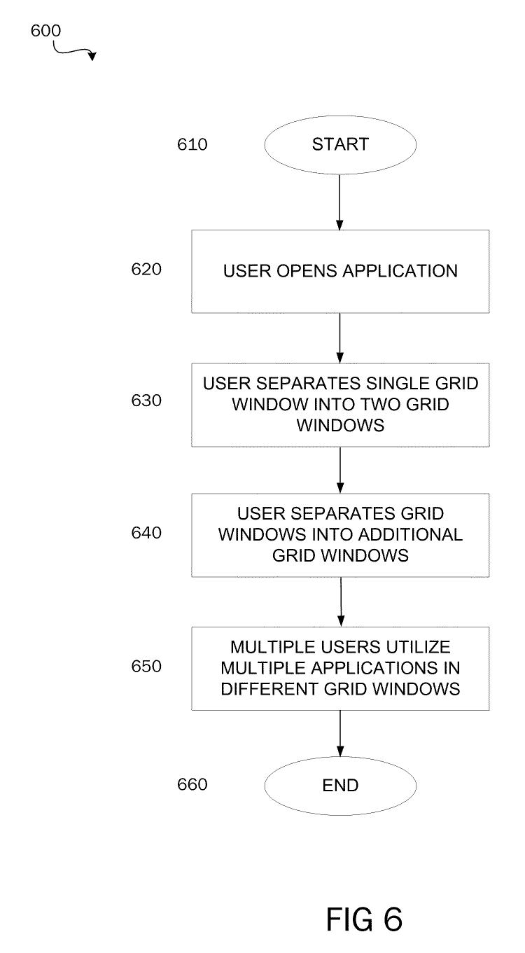

The method ends at operation 660. It should be appreciated that the logical flow diagram illustrated in FIG. 6 and described above is merely one example of a method for providing a plurality of grid windows wherein independent application functionally and associated content may be displayed on a multi-touch display.

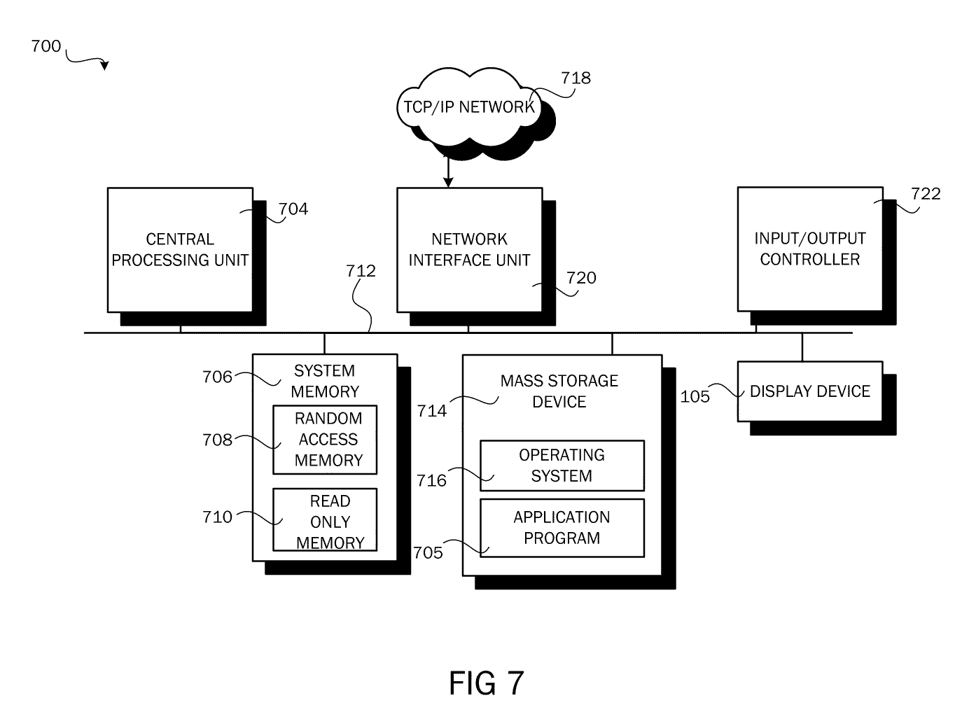

Referring now to FIG. 7, an illustrative computer architecture for an electronic computing device 700 for practicing the various embodiments of the invention will be described. The computer architecture shown in FIG. 7 illustrates a conventional electronic computing device, including a central processing unit 704 (“CPU”), a system memory 706, including a random access memory 708 (“RAM”) and a read-only memory (“ROM”) 710, and a system bus 712 that couples the memory to the CPU 704. A basic input/output system containing the basic routines that help to transfer information between elements within the computer, such as during startup, is stored in the ROM 710. The electronic computing device 700 further includes a mass storage device 714 for storing an operating system 716, application programs 705, and data.

The mass storage device 714 is connected to the CPU 704 through a mass storage controller (not shown) connected to the bus 712. The mass storage device 714 and its associated computer-readable media, provide non-volatile storage for the electronic computing device 700. Although the description of computer-readable media contained herein refers to a mass storage device, such as a hard disk or CD-ROM drive, it should be appreciated by those skilled in the art that computer-readable media can be any available media that can be accessed by the electronic computing device 700.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the electronic computing device 700 may operate in a networked environment using logical connections to remote computers through a TCP/IP network 718, such as the Internet. The electronic computing device 700 may connect to the TCP/IP network 718 through a network interface unit 720 connected to the bus 712. It should be appreciated that the network interface unit 720 may also be utilized to connect to other types of networks and remote computer systems. The electronic computing device 700 may also include an input/output controller 722 for receiving and processing input from a number of devices, including a keyboard or mouse (not shown). Similarly, an input/output controller 722 may provide output to a display screen, a printer, or other type of output device.

As mentioned briefly above, a number of program modules and data files may be stored in the mass storage device 714 and RAM 708 of the electronic computing device 700, including an operating system 716 suitable for controlling the operation of a networked electronic computing device, such as the WINDOWS operating systems from MICROSOFT CORPORATION of Redmond, Wash. The mass storage device 714 and RAM 708 may also store one or more application programs 705.

Electronic computing device 700 also comprises a display device 105 that is operative to display a graphical user interface that provides an interface between a user of the electronic computing device 700 and the operating system 716 or application 705 running thereon. Display device 105 may be a variety of different types of display devices. For instance, display device 105 may be an LCD display panel, a plasma screen display panel, a touch-sensitive display panel, a LED array, or another type of display device.

Electronic computing device 700 may also comprise a touchscreen 735 that is configured to input information into the electronic computing device 700. The touchscreen 735 may, for example, be utilized to select a displayed icon or element with respect to the graphical user interface on the display 105 by touching the screen 735 in a location corresponding to the desired icon or element. Touchscreen 735 may be responsive to mechanical or electrical stimuli through a variety of means, including but not limited to: passive or capacitive digitizing technology, heat, finger pressure, high capture rate cameras, infrared light, optic capture, tuned electromagnetic induction, ultrasonic receivers, transducer microphones, laser rangefinders, shadow capture, and the like. As should be appreciated by those skilled in the art, touch recognition and multi-touch technology are known technologies that will not be discussed at length herein.

As described herein, facilitating multi-user input on large format displays is provided. It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A method for dividing a display window into a plurality of display windows that may be utilized independently and concurrently; comprising
providing a computer-generated display window on which computer-enabled content may be utilized;
dividing the display window into a plurality of separate display windows;
wherein each separate display window may be utilized independently of other separate display windows and wherein each separate display window may be utilized concurrently with other separate display windows.

2. The method of claim 1, wherein providing a computer-generated display window on which computer-enabled content may be utilized includes providing a multi-touch display.

3. The method of claim 1, wherein providing a computer-generated display window on which computer-enabled content may be utilized includes providing a large format display.

4. The method of claim 1, further comprising displaying a first content in a first of the plurality of separate display windows, and displaying an instance of the first content in a second of the plurality of separate display windows, wherein the first content and the instance of the first content may be utilized independently of each other and wherein the first content and the instance of the first content may be utilized concurrently with each other.

5. The method of claim 1, further comprising displaying a first content in a first of the plurality of separate display windows, and displaying a second content in a second of the plurality of separate display windows wherein the first and second content may be utilized independently of each other and wherein the first and second content may be utilized concurrently with each other.

6. The method of claim 1, further comprising displaying a first application functionality in a first of the plurality of separate display windows, and displaying an instance of the first application functionality in a second of the plurality of separate display windows, wherein the first application functionality and the instance of the first application functionality may be utilized independently of each other and wherein the first application functionality and the instance of the first application functionality may be utilized concurrently with each other.

7. The method of claim 1, further comprising displaying a first application functionality in a first of the plurality of separate display windows, and displaying a second application functionality in a second of the plurality of separate display windows wherein the first and second application functionality may be utilized independently of each other and wherein the first and second application functionality may be utilized concurrently with each other.

8. The method of claim 5, further comprising binding the first content to the second content such that changes to the first content cause any corresponding changes to be made to the second content.

9. The method of claim 1, wherein dividing the display window into a plurality of separate display windows includes moving a divider from an edge of the display window to a desired location on the display window.

10. The method of claim 9, wherein moving the divider from an edge of the display window to a desired location on the display includes depositing the divider at the desired location causing a separation of the display window into multiple display windows where a first display window is created on one side of the deposited divider and wherein a second display window is created on an opposite side of the deposited divider, and wherein a size of each of the first and second display windows is defined by the location of the deposited divider on the display window and on a size of the display window.

11. The method of claim 10, further comprising establishing a new edge for each of the first and second display windows at a position between the first and second display windows at the location of the deposited divider, wherein a second divider may be instantiated over the new edge, wherein said second divider may be moved to a second desired location in one of the first and second display windows for separating the first or second display windows into multiple display windows.

12. The method of claim 10, wherein moving the divider from an edge of the display window to a desired location on the display window and wherein depositing the divider at the desired location includes dragging the divider from the edge of the display window and dropping the divider at the desired location.

13. The method of claim 10, further comprising resizing a given first or second display window by moving the deposited divider from the desired location to a different desired location.

14. The method of claim 9, wherein moving a divider from an edge of the display window to a desired location on the display window includes moving a horizontal divider from an upper or lower edge of the display window for separating the display window into upper and lower separate display windows.

15. The method of claim 9, wherein moving a divider from an edge of the display window to a desired location on the display window includes moving a vertical divider from a side edge of the display window for separating the display window into side-by-side separate display windows.

16. The method of claim 9, further comprising collapsing a given display window by moving a divider over the given display window and depositing the divider such that the given display window is removed from display.

17. A computer-readable medium on which is stored computer-executable instructions, which when executed by a computer perform a method for dividing a display window into a plurality of display windows that may be utilized independently and concurrently; comprising
providing a computer-generated display window on which computer-enabled content may be utilized;
dividing the display window into a plurality of separate display windows;
allowing a displaying of a first content in a first of the plurality of separate display windows, and allowing a displaying of a second content in a second of the plurality of separate display windows, wherein the first content and the second content may be utilized independently of each other, and wherein the first content and the second content may be utilized concurrently with each other.

18. The computer-readable medium of claim 17, wherein the second content is a copy of the first content that may be utilized independently and concurrently in the second of the plurality of separate display windows.

19. The computer-readable medium of claim 17, wherein first and second content include first and second application functionality, respectively.

20. A method for dividing a display window into a plurality of display windows that may be utilized independently and concurrently; comprising
providing a computer-generated display window on which computer-enabled content may be utilized;
dividing the display window into a plurality of separate display windows by moving a divider from an edge of the display window and by depositing the divider at a desired location on the display window;
establishing a new edge for each of a first and second display windows of the plurality of separate display windows at a position between the first and second display windows at the location of the deposited divider, wherein a second divider may be instantiated over the new edge, wherein said second divider may be moved to a second desired location in one of the first and second display windows for separating the first or second display windows into multiple display windows;
wherein each of the separate or multiple display windows may be utilized independently of other separate or multiple display windows and wherein each of the separate or multiple display windows may be utilized concurrently with other separate or multiple display windows.
